(19) United States
(12) Patent Application Publication
(10) Pub. No.: US 2026/0225215 A1
(43) Pub. Date: Aug. 6, 2026

(54) STAKE DRIVING TOOL, SYSTEM, AND METHOD

(71) Applicant: USA Sign Frame and Stake Inc., Zeeland, MI (US)

(72) Inventor: Brian Kronemeyer, Zeeland, MI (US)

(73) Assignee: USA Sign Frame and Stake Inc., Zeeland, MI (US)

(21) Appl. No.: 19/459,679

(22) Filed: Jan. 26, 2026

Related U.S. Application Data
(60) Provisional application No. 63/760,966, filed on Feb. 20, 2025.
(60) Provisional application No. 63/752,217, filed on Jan. 31, 2025.

(51) Int. Cl. B25D 1/16

(52) U.S. Cl. CPC B25D 1/16

(57) ABSTRACT

A stake driving tool for landscaping and construction addresses the labor-intensive task of driving stakes into the ground. The tool has a guide tube with a hollow interior, a hammer shaft that moves between raised and lowered positions in the guide tube, and a stake magazine holding multiple interconnected stakes that are gravity fed into the guide tube. The chamber of the guide tube receives the stakes in alignment with the hammer shaft, allowing the hammer shaft to engage and drive stakes into the ground in an efficient manner. This system reduces manual effort and ensures consistent stake placement, enhancing safety and productivity in large-scale projects. The tool facilitates continuous operation without frequent reloading, making the tool suitable for extensive landscaping and construction applications.

### CROSS-REFERENCE TO RELATED APPLICATIONS

This application claims the benefit and priority under 35 U.S.C. §119(e) of U.S. provisional application Ser. No. 63/752,217, filed on January 31, 2025, and U.S. provisional application Ser. No. 63/760,966, filed on February 20, 2025, the contents of which are incorporated herein by reference in their entirety.

### TECHNICAL FIELD

The present disclosure relates generally to systems and tools for driving stakes into the ground, and more specifically to tools for driving landscape or garden stakes into the ground for securing an item to the ground, such as fabric, pipes, and artificial grass.

### BACKGROUND

In the field of landscaping and construction, driving stakes into the ground is a common yet labor-intensive task. Traditionally, this has been done using manual tools such as hammers or mallets, which require significant physical effort and can lead to inconsistent results. These methods often result in stakes that are not securely anchored, posing potential safety hazards and necessitating frequent adjustments or replacements. Additionally, manual stake driving can be time-consuming, particularly in large-scale projects where numerous stakes may be required, often in relatively compressed timeframes to secure netting or underlayment to soil before weather events cause movement or disturbances to the material that the stakes function to secure.

### SUMMARY

According to an aspect of the disclosure, a tool is provided for driving a landscape stake into a ground substrate. The tool includes a guide tube having a bottom end configured to rest on a ground surface, a top end at an opposite longitudinal extent of the guide tube, and a hollow interior disposed along the longitudinal extent of the guide tube. A hammer shaft is slidably disposed in the hollow interior of the guide tube and is movable between a raised position and a lowered position. A stake magazine is attached to a lower portion of the guide tube and has an interior configured to hold a plurality of stakes, such as at an angle that permits gravity to feed the stakes into the guide tube. When the hammer shaft is in the raised position, a lower portion of the guide tube is configured to receive a lowermost stake of the plurality of stakes in the stake magazine. When the hammer shaft is moved from the raised position toward the lowered position, a lower end of the hammer shaft is configured to engage a head of the lowermost stake and drive it down the lower portion of the guide tube into the ground surface. For instance, the lower end of the guide tube receives the lowermost stake in axial alignment with the hammer shaft.

According to another aspect of the disclosure, a tool is provided for driving a landscape stake into a ground substrate, where the tool has a base plate that is configured to rest on a ground surface. A guide tube extends upward from the base plate and defines a hollow interior. A hammer shaft is slidably disposed in the hollow interior of the guide tube and is movable between a raised position and a lowered position. A stake magazine is attached to a lower portion of the guide tube and has an interior configured to hold a plurality of interconnected stakes. The lower portion of the guide tube includes a chamber with an opening aligned with the interior of the stake magazine, such that when the hammer shaft is in the raised position, the chamber of the guide tube is configured to receive a lowermost stake of the plurality of interconnected stakes through the opening and into the guide tube. When the hammer shaft is moved from the raised position toward the lowered position, a lower end of the hammer shaft is configured to engage a head of the lowermost stake and drive the stake down the lower portion of the guide tube into the ground surface.

In some examples, an upper end of the hammer shaft is attached to a handle that is operable for a user to move the hammer shaft between the raised and lowered positions. The handle, in some implementations, includes a slide limiter that is configured to contact a stop surface on the guide tube when the hammer shaft is in the lowered position. For example, the handle may extend upward from the top end of the guide tube. In other examples, the handle extends outward through a slot formed longitudinally along an upper end of the guide tube, such that the slot may include a lower end that limits downward movement of the hammer shaft beyond the lowered position. The slot may include an upper end that limits upward movement of the hammer shaft beyond the raised position. In some examples, the hammer shaft is spring-biased in the guide tube toward the raised position. Also, the lower end of the hammer shaft, in some examples, includes an impactor member, which may be weighted more than the upper end of the hammer shaft.

In additional examples, the stake magazine includes an upward-facing channel that defines slide supports on opposing longitudinal sides of the channel. The slide supports may be configured to support the plurality of stakes in the channel. In some examples, the side surface of the lower end of the hammer shaft is configured to retain the remainder of the plurality of stakes in the magazine when the hammer shaft is moved to the lowered position. Also, in some examples, the lower end of the hammer shaft is generally aligned with the bottom end of the guide tube when the hammer shaft is in the lowered position.

According to a further aspect of the disclosure, a system is provided that includes a stake driving tool having a guide tube with an upper end, a lower end that includes a flange configured to engage and resist penetrating a ground surface, and a hollow interior between the upper and lower ends. The tool has a hammer shaft that is slidably disposed in the hollow interior of the guide tube and is movable between a raised position and a lowered position. The tool also has a stake magazine attached to a lower portion of the guide tube and extending upward from the guide tube at an angle. The system also provides a stake strip that is disposed in an interior of the stake magazine. The stake strip has a plurality of stakes that are molded together in parallel alignment at an angle corresponding to the angle of the stake magazine. The stakes are molded together with spacer pieces connecting adjacent stakes of the stake strip. When the hammer shaft is in the raised position, the chamber of the guide tube is configured to receive a lowermost stake of the plurality of stakes through the opening and into the hollow interior of the lower portion of the guide tube. When the hammer shaft is moved from the raised position toward the lowered position, a lower end of the hammer shaft is configured to engage a head of the lowermost stake and drive the stake down the lower portion of the guide tube into the ground surface.

In some examples, the system further includes a handle coupled with an upper end of the hammer shaft. The lower end of the hammer shaft may include an impactor member. Also, in some examples, the handle limits downward movement of the hammer shaft beyond the lowered position. In some implementations, the hammer shaft may be spring-biased in the guide tube toward the raised position. The stake magazine may include slide supports on opposing longitudinal sides of the stake magazine that contact and support opposing alignment pegs of the plurality of stakes held in the stake magazine. The lower end of the hammer shaft may include a side wall that is configured to retain the remainder of the plurality of stakes in the magazine when the hammer shaft is moved toward the lowered position.

According to another aspect of the disclosure, a method is provided for driving a landscape stake into a ground substrate using a stake driving tool. The method involves positioning a base plate of the stake driving tool on a ground surface to provide a stable foundation. In some examples, the tool may include a carry handle fixed to an exterior side wall of the guide tube for supporting the tool in operation and for moving the tool over the ground surface. A plurality of interconnected stakes are loaded into a stake magazine attached to a lower portion of a guide sleeve extending upward from the base plate, the guide sleeve defining a hollow interior; aligning a lowermost stake of the plurality of interconnected stakes with a chamber in the lower portion of the guide sleeve through an opening in the stake magazine. A hammer shaft slidably disposed within the hollow interior of the guide sleeve is raised to a raised position, allowing the chamber to receive the lowermost stake. The hammer shaft is moved from the raised position toward a lowered position, where a lower end of the hammer shaft engages a head of the lowermost stake. The lowermost stake is driven down the lower portion of the guide sleeve and into the ground surface by the movement of the hammer shaft. The steps may be repeated for subsequent stakes in the stake magazine as needed. The stake magazine is configured to move stakes into the guide sleeve under the weight of gravity and includes a visual indicator to show the number of remaining stakes.

Implementations of the disclosure may include one or more of the preceding features in various combinations. The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a perspective view of a stake driving tool.

FIG. 2 is a side, cross-sectional view of the stake driving tool in a raised position.

FIG. 3 is a side, cross-sectional view of the stake driving tool in a lowered position with a stake being driven into the ground substrate.

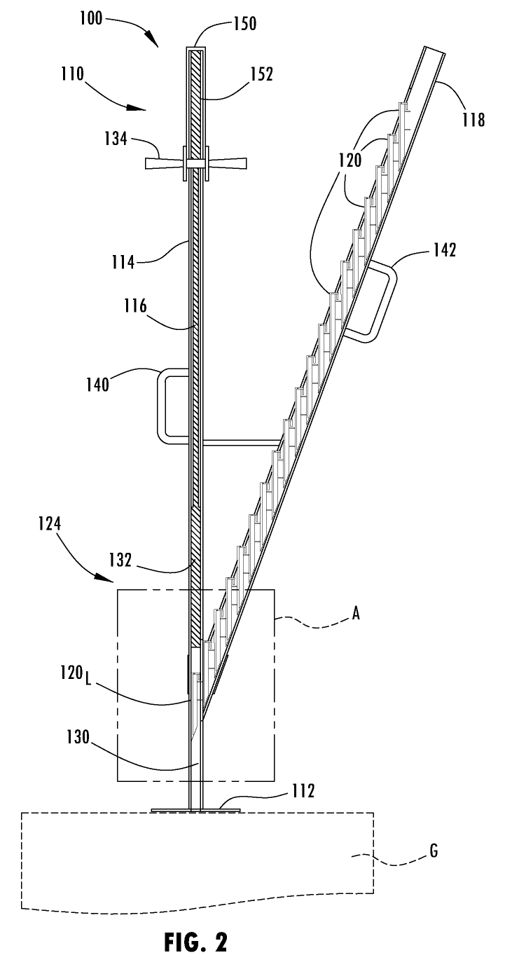

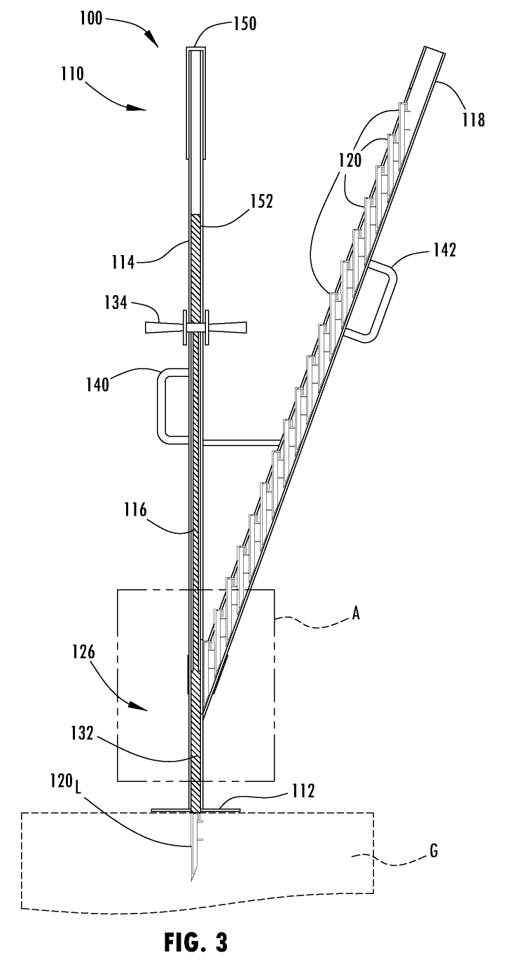

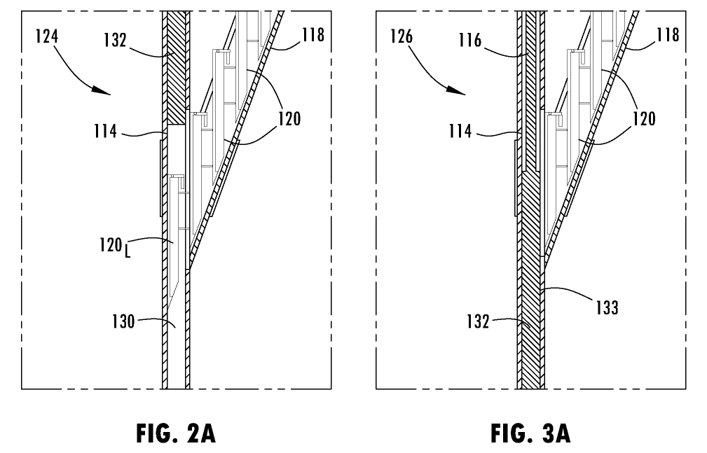

FIG. 2A is an enlarged view of section A of FIG. 2, showing the lowermost stake in the chamber with the stake driving tool in the raised position.

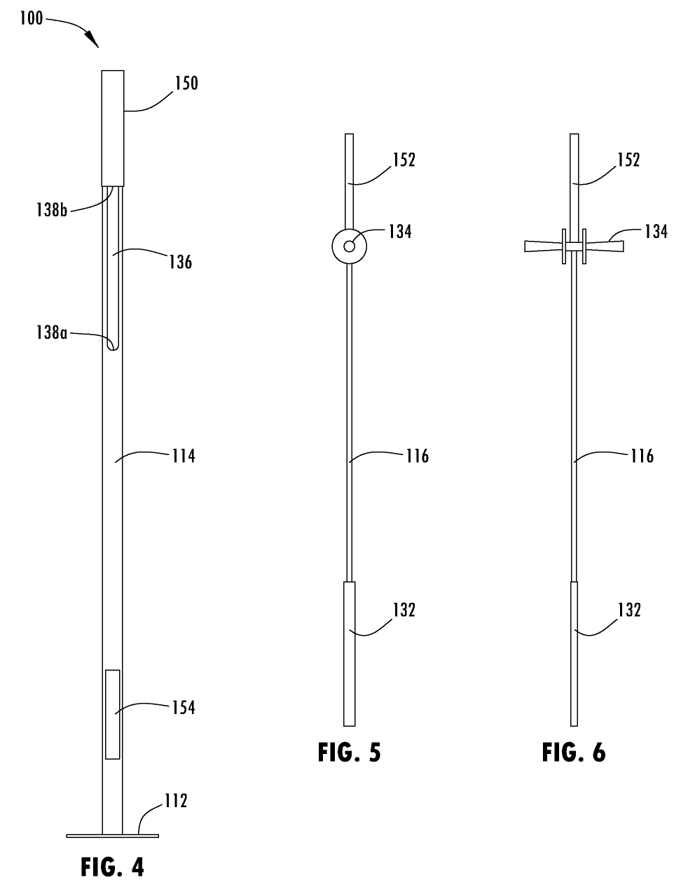

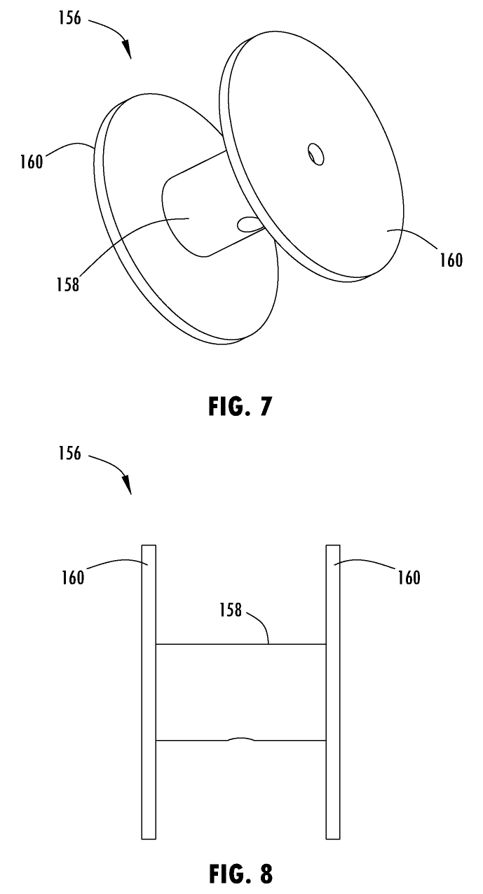

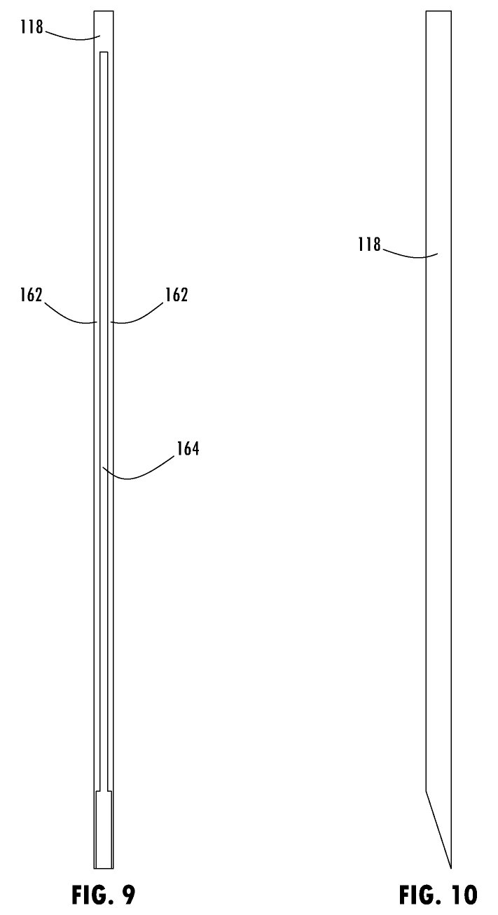

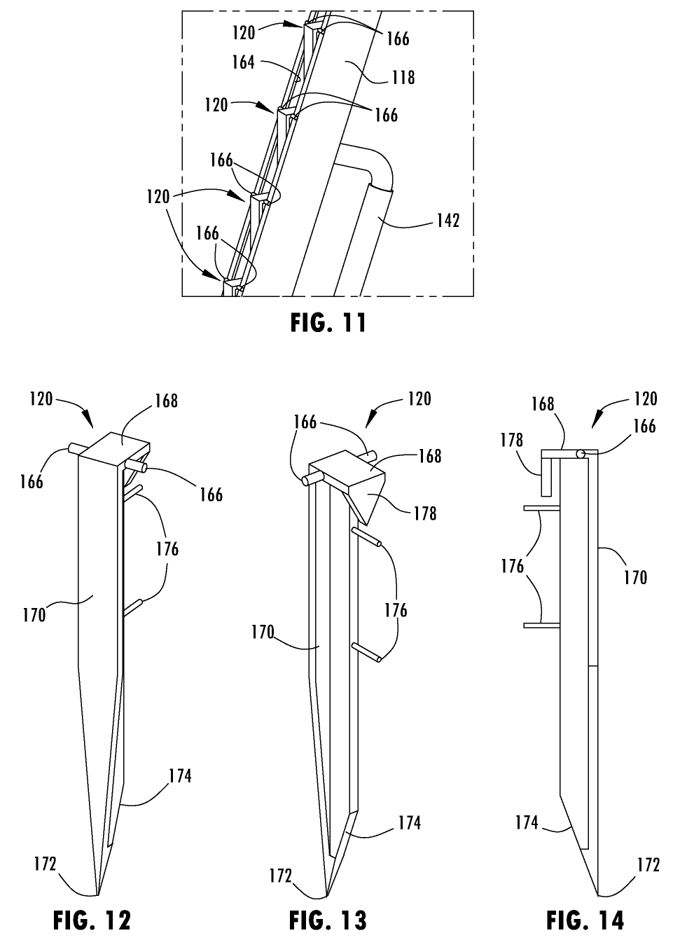

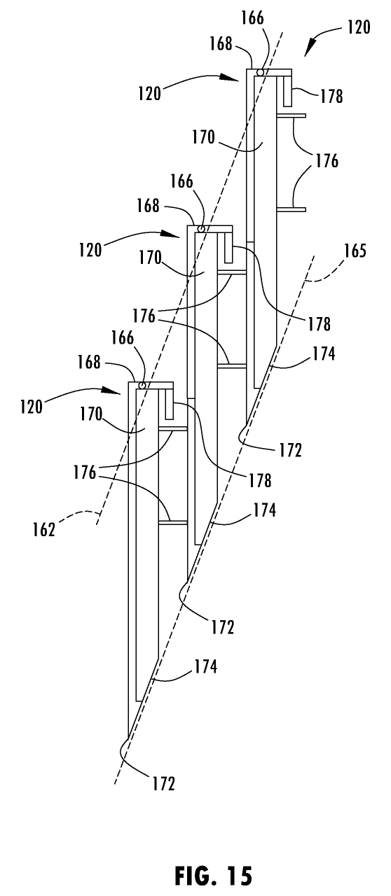

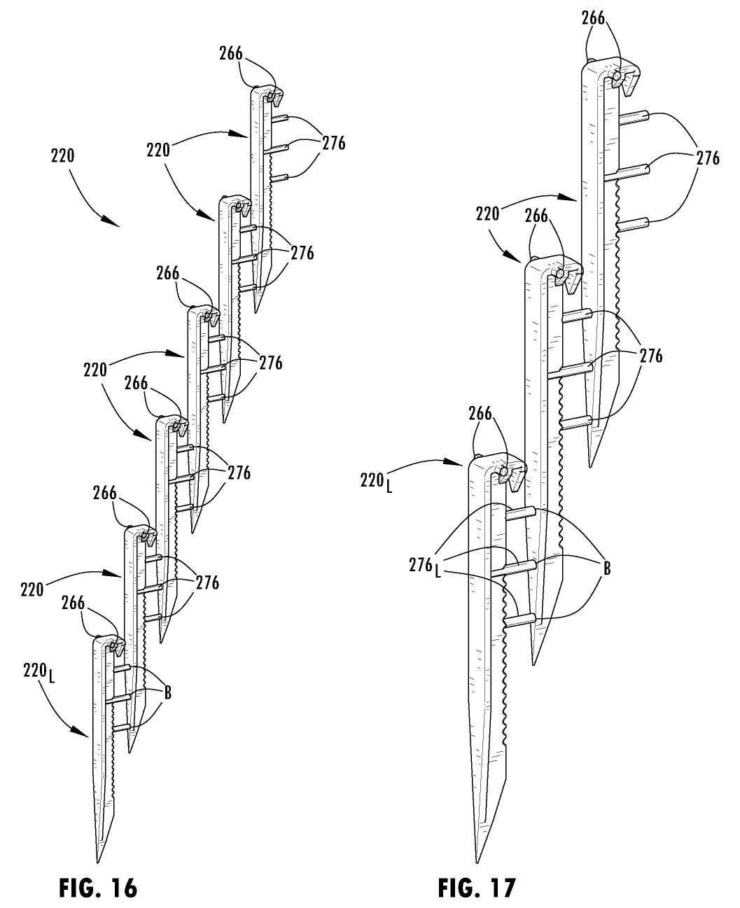

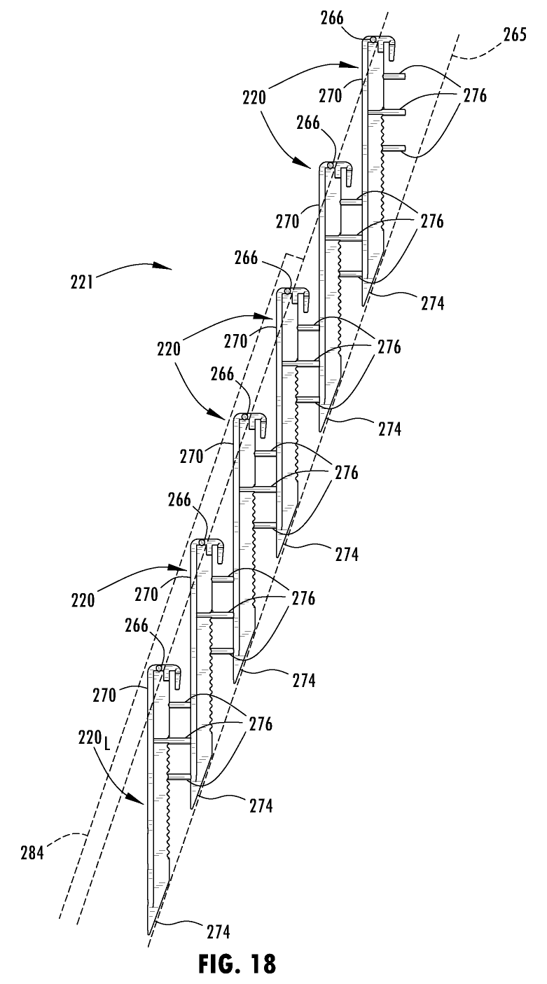

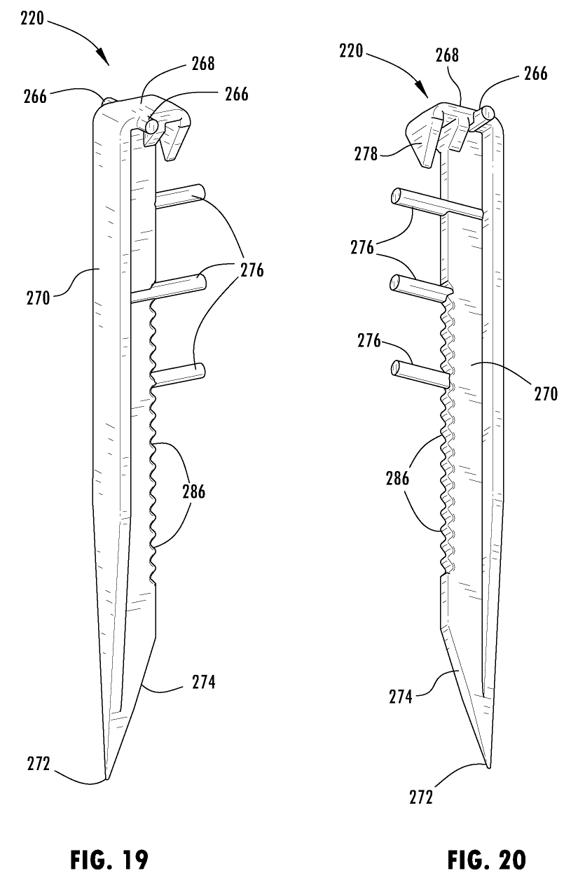

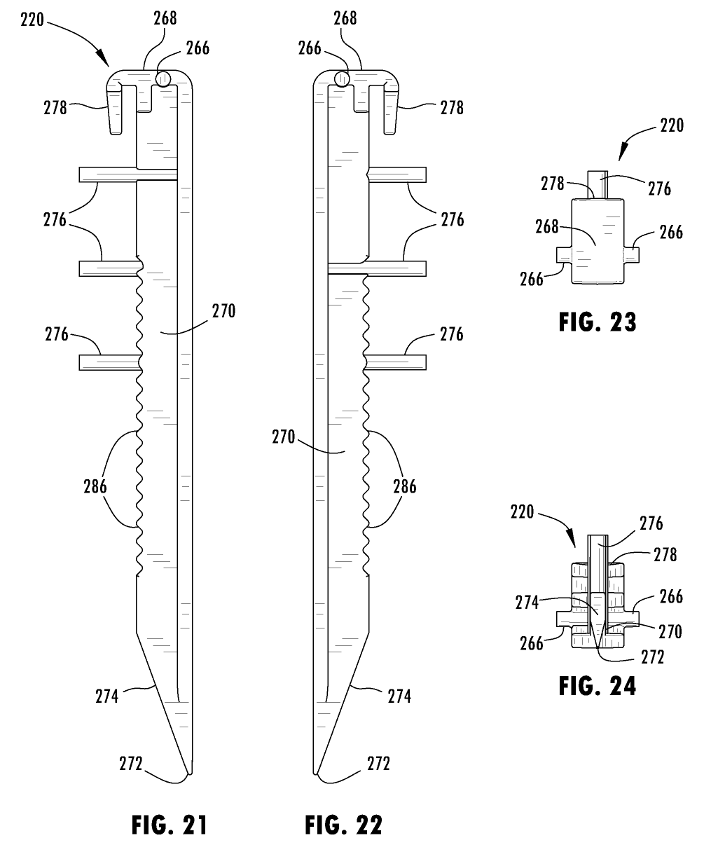

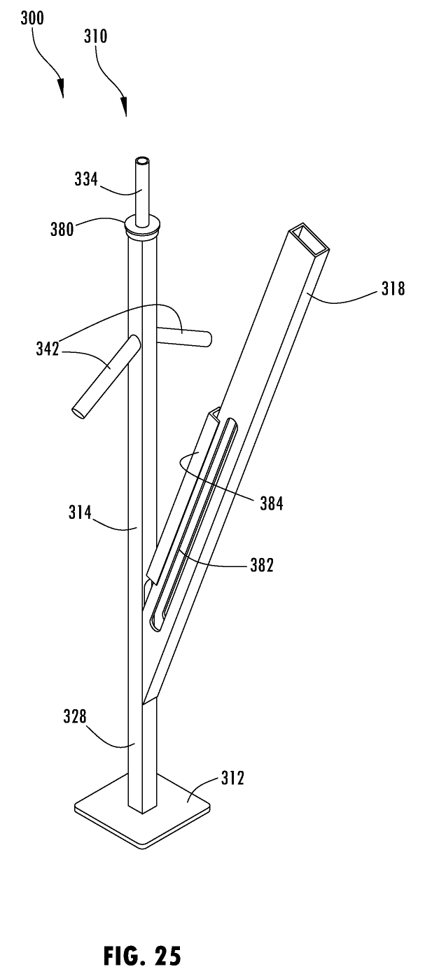

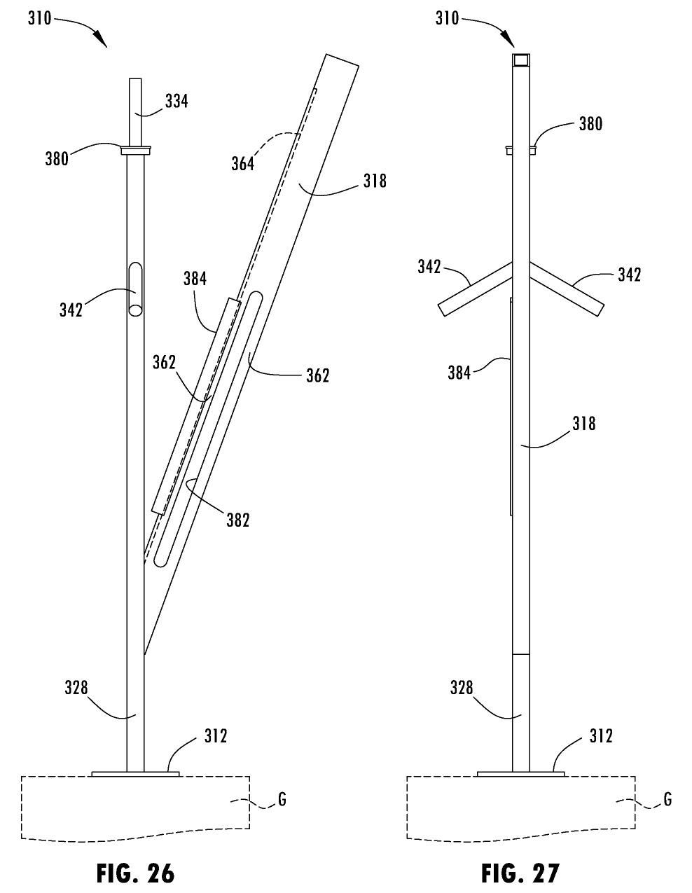

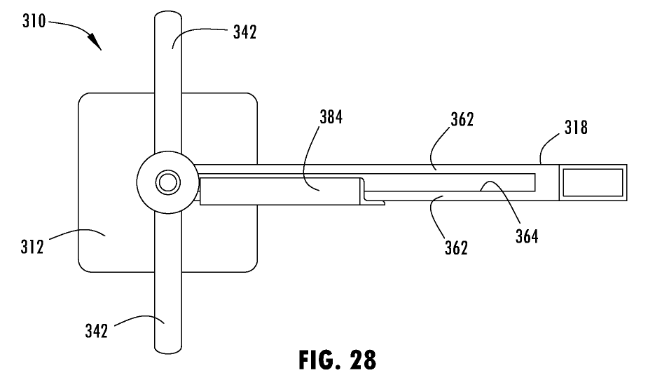

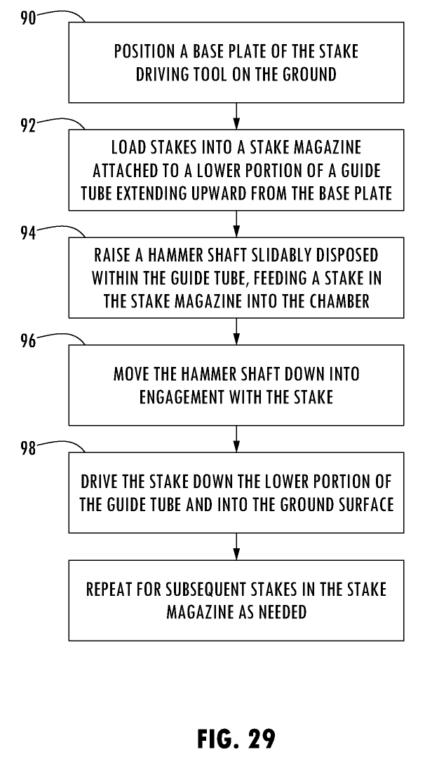

FIG. 3A is an enlarged view of section A of FIG. 3, showing the hammer shaft moved down in the chamber with the stake driving tool in the lowered position.

FIG. 4 is a side view of the guide tube of the stake driving tool.

FIG. 5 is a side view of the hammer shaft of the stake driving tool.

FIG. 6 is another side view of the hammer shaft assembly of the stake driving tool.

FIG. 7 is a perspective view of a spindle of the handle assembly.

FIG. 8 is a side view of the spindle shown in FIG. 7.

FIG. 9 is a side view of the stake magazine showing the slide supports and channel.

FIG. 10 is another side view of the stake magazine.

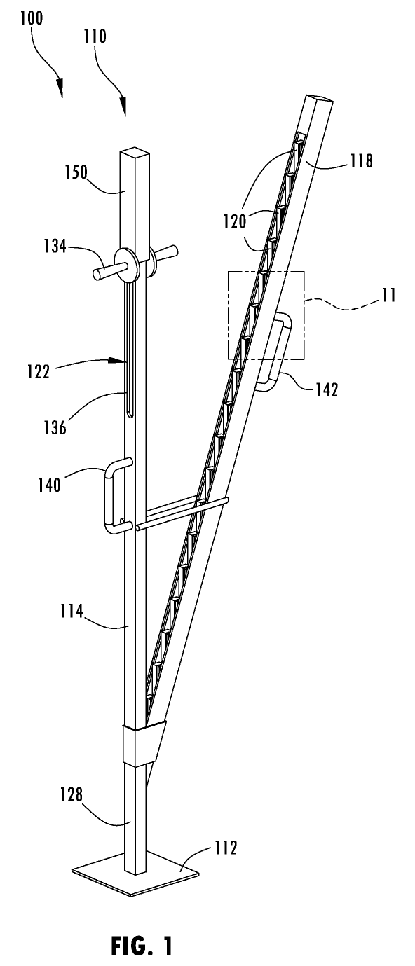

FIG. 11 is an enlarged view of section 11 of FIG. 1, showing the stake magazine and the stakes held in the channel.

FIG. 12 is a front, perspective view of a stake shown in FIG. 11.

FIG. 13 is a rear, perspective view of the stake shown in FIG. 12.

FIG. 14 is a side view of the stake shown in FIG. 12.

FIG. 15 is a schematic side view of stakes arranged in the stake magazine, showing spacer features interconnecting between the stakes.

FIG. 16 is a front, perspective view of a stake strip.

FIG. 17 is a partial front, perspective view of the stake strip shown in FIG. 16.

FIG. 18 is a side view of the stake strip shown in FIG. 16.

FIG. 19 is a front, upper perspective view of a stake from the stake strip of FIG. 16.

FIG. 20 is a rear, lower perspective view of the stake shown in FIG. 19.

FIG. 21 is a left side view of the stake shown in FIG. 19.

FIG. 22 is a right side view of the stake shown in FIG. 19.

FIG. 23 is a top view of the stake shown in FIG. 19.

FIG. 24 is a bottom view of the stake shown in FIG. 19.

FIG. 25 is a perspective view of an additional example of a stake driving tool.

FIG. 26 is a side view of the stake driving tool shown in FIG. 25.

FIG. 27 is another side view of the stake driving tool shown in FIG. 25.

FIG. 28 is a top view of the stake driving tool shown in FIG. 25.

FIG. 29 is a flow chart showing a method of operating a stake driving tool.

Like reference numerals indicate like parts throughout the drawings.

### DETAILED DESCRIPTION

Referring to the drawings, a system 100 is provided with a portable tool 110 for manually driving stakes 120, such as compostable, biodegradable landscape stakes, into a ground substrate G. The ground substrate G may be various types of elements and compaction levels, such as various combinations of natural earth or synthetic materials, including soil, sand, clay, compost, gravel, and the like. As used herein, the terms “ground surface” and “ground substrate” are used interchangeably to refer to the upper exposed surface and underlying subsurface material into which stakes are driven. References to driving stakes “into the ground surface” encompass penetration into the ground substrate below the visible surface. As shown in FIG. 1, the tool 110 includes a base plate 112, a guide tube 114, a hammer shaft 116, and a stake magazine 118. The arrangement of these components provides a systematic approach to stake driving, reducing manual effort and increasing efficiency, while also being portable and ergonomic for a single user. The base plate 112 of the tool 110 provides a stable foundation, ensuring that the tool remains steady during operation. The guide tube 114 extends upward from the base plate 112 and defines a hollow interior 122 that guides movement of the hammer shaft 116. The hammer shaft 116 is slidably disposed within the guide tube 114 and moves between a raised position 124 (FIG. 2) and a lowered position 126 (FIG. 3), allowing for controlled impact on the stake head. This configuration minimizes the risk of misalignment and ensures that stakes are driven straight and securely into the ground substrate G in a consistent and repeatable manner.

In some implementations, the stakes 120, 220 are formed from a biodegradable composite material, such as a plant-based polymer composite, cornstarch-based composite, or other organic material that naturally decomposes when driven into and left in the ground substrate. Such biodegradable materials eliminate the need for stake removal and reduce environmental impact in landscaping applications. In other implementations, the stages 120, 220 are formed from an injection molded polymer material, such as for applications where removal is contemplated.

As also shown in FIG. 1, the stake magazine 118 is attached to the lower portion 128 of the guide tube 114, extending radially from the guide tube and upward at an angle that allows the stakes to be gravity fed into the guide tube 114 during operation of the tool. The stake magazine 118 holds a plurality of interconnected stakes 120, such as one or more interconnected sets or strips of stakes, facilitating generally continuous operation and reducing the need for frequent reloading. The chamber 130 in the lower portion 128 of the guide tube 114 is aligned with the open end of the stake magazine 118 and provides an opening 154 (FIG. 4) in the sidewall of the guide tube 114 that is in communication with the interior of the stake magazine 118. Specifically, the chamber 130 is defined by a section of the hollow interior 122 at the lower portion 128 of the guide tube 114, and the opening 154 provides a lateral passage connecting the interior of the stake magazine 118 directly to the chamber 130, allowing stakes to move laterally from the magazine into axial alignment within the guide tube. The stake magazine 118 allows for the hands-free feeding of stakes 120 into the guide tube 114, providing a smooth and efficient driving process. The gravity fed magazine enhances the speed of stake installation and also reduces the physical strain on the user, as the tool automates much of the manual labor traditionally associated with stake driving. By integrating these components, the tool offers a practical solution to the challenges of manual stake driving, providing a more reliable and time-efficient method suitable for large-scale landscaping and construction projects.

As shown in operation in FIGS. 2 and 3, the hammer shaft is moved from the raised position 124 to the lowered position 126. In the raised position 124, the lowermost stake 120_{L} in the stake magazine 118 is fed into the chamber 130 with the side surface of the stake abutting the interior surface of the guide tube 114, which prevents the adjacent stake 120 from entering the chamber 130. As shown in more detail in FIG. 2A, the interior area of the guide tube 114 is sized to receive a single stake. In the raised position 124, the bottom end of the hammer shaft 116 is raised above the upper end of the opening 154 on the sidewall of the guide tube 114, so that the hammer shaft 116 does not impinge or prevent the lowermost stake 120L from smoothly entering the chamber 130.

When the lowermost stake 120_{L} has completely advanced into the chamber 130, the hammer shaft 116 may be driven downward, such as by a user pushing down on the handle 134. However, it is conceivable that in other examples mechanical devices may be incorporated to assist with or provide the downward force on the hammer shaft, such as with pneumatic actuators or other types of linear actuators. The downward force on the hammer shaft 116 drives the impactor member 132 at the bottom end of the hammer shaft 116 into engagement with the head of the lowermost stake 120_{L}, such as to cause a forceful axial impact to the stake. Upon impact with the lowermost stake 120_{L}, the stake is driven downward relative to the guide tube 114. Due to the generally axial alignment of the lowermost stake 120_{L} in the chamber 130 with the hammer shaft 116 and its corresponding impactor member 132, the impact forces delivered to the stake are efficiently transferred to axial and linear movement of the stake along the lower portion of the guide tube 114, so as to exit the tool with sufficient force to be driven into the ground substrate G.

As also shown in FIGS. 2 and 3, the adjacent stake is connected to the stake being driven downward, such that the connection is broken by shear forces resulting from the downward force acting on the lowermost stake. With sufficient downward force, the shear forces cause the driven stake 120 to break away and separate from the adjacent stake as it moves downward in the chamber toward the ground substrate. As shown in FIG. 3A, once the lower end of the hammer shaft is driven sufficiently downward to advance the lowermost stake 120_{L} downward, a side surface 133 of the hammer shaft 116 also retains the remainder of the plurality of stakes in the magazine 118. The side surface at the lower end of the hammer shaft 116, shown in FIG. 3A as the side surface of the impactor member 132, is configured to retain the remainder of the plurality of stakes 120 in the magazine 118 when the hammer shaft is moved by the user toward and into the lowered position 126.

To provide a location for the handle 134 that allows a user in a standing stance to have leverage to easily drive the hammer shaft 116 downward, the handle 134 of the stake driving tool 110 is coupled with an upper portion of the hammer shaft 116. As shown in FIGS. 1-3, the handle 134 has a handle grip extending from both sides of the hammer shaft 116, such that the handle grips can be grasped by either hand or both hands of a user to drive the hammer shaft 116 downward. The grips of the handle 134 extend laterally outward from opposing sides of the guide tube 114. As shown in FIG. 4, the handle 134 extends through a slot 136 formed longitudinally along an upper end of the guide tube 114. The slot 136 includes a lower end 138a that limits downward movement of the handle 134 and in turn limits the attached hammer shaft 116 beyond the lowered position. The upper end 138b of the slot 136 that limits upward movement of the handle 134 and in turn the attached hammer shaft 116 beyond the raised position. As shown in FIG. 4, the upper end 138b of the slot 136 is defined by a curved lower surface of a cap 150 attached to the top of the guide tube 114. It is understood that the slot in additional examples may be shorter or longer to allow for a different stroke distance of the hammer shaft. Similarly, the length of the hammer shaft and attachment location of the handle may be different or adjustable in other embodiments to provide similar types of modifications to operation of the tool.

As further shown in FIG. 4, the lower end of the guide tube 114 is attached to the base plate 112 around a central opening in the base plate 112, which the stake is driven through. The central opening has a rectangular shape that corresponds to the cross-sectional interior area of the guide tube 114. In other words, the base plate 112 functions as a flange extending radially outward from the lower end of the guide tube 114. Alternatively, in other implementations, a flange may be formed as an integral radial extension of the guide tube itself, or as a separate component attached to the guide tube, rather than being provided as a separate base plate structure. The base plate 112 extends radially outward from the guide tube 114 a sufficient distance to create a downward-facing surface area that prevents intrusion into the ground surface when locating the tool 110 at a position to drive a stake into the ground surface. The base plate distributes the weight and force exerted by the tool over a larger area, thereby preventing the guide tube from penetrating or sinking into the ground when the tool is positioned to drive a stake. This can be particularly useful when working on softer ground surfaces, where there is a higher risk of the tool sinking. Additionally, the lateral planar extension of the base plate contributes to the stability of the tool, reducing the likelihood of tipping or shifting during operation. In additional examples, it is understood that the base plate may be omitted or replaced with alternative structures that supportively engage the ground and prevent penetration or sinking.

To improve the ease of portably moving the tool by hand and without the use of other tools or users, one or more fixed handles or grasping areas may be incorporated on the tool. For example, as shown in FIGS. 1-3, a first carry handle 140 is attached to the guide tube 114 and a second carry handle 142 is attached to the stake magazine 118. The carry handles 140, 142 are attached to opposing sides of the tool, providing convenient and ergonomic locations for users to lift and maneuver the stake driving tool 110. The handles are provided by U-shaped bars that offer a comfortable and stable grip that allow the user's hand to not rely entirely on grip strength, such that the user's hand can contact the upper interior surfaces of the U-shape, which may reduce user fatigue during prolonged use.

In some examples, such as shown in FIGS. 2-6, the hammer shaft 116 may be spring-biased in the guide tube 114, such as toward the raised position 124. To provide the upward spring-bias to the hammer shaft 116, the cap 150 attached to the upper end of the guide tube 114 may be operably attached to the upper end of the hammer shaft 116 via a spring 152. The spring 152 provides the upward bias as a tension spring that is attached between the upper end of the hammer shaft 116 and the interior of the cap 150. By biasing the hammer shaft 116 upward relative to the guide tube 114 with the spring 152, the amount of force required to lift the hammer shaft 116 after driving a stake down into the lowered position may be reduced. While illustrated as a tension spring 152 connected between the cap 150 and the upper end of the hammer shaft 116, other spring configurations are possible in alternative implementations, including compression springs disposed within the hollow interior below the hammer shaft, torsion springs, or elastomeric biasing members. The cap 150 may also serve as a protective cover, such as to shield the internal components of the tool from external elements. Additionally, the cap may contribute to the structural integrity of the system, by structurally joining the opposing walls of the guide tube, as shown in FIG. 4.

With further reference to the handle 134 shown in FIGS. 5-8, the handle grips extending from both sides of the guide tube 114 can be grasped by either or both hands of a user to drive the hammer shaft 116 downward. The handle grips of the hammer shaft 116 are joined together with a spindle 156 of the handle assembly. The spindle 156 functions as the core of the handle assembly with a central shaft 158 that extends between guide plates 160. The central shaft 158 provides a central structure that moves within the slot 136 of the guide tube 114, where the guide plates 160 prevent lateral movement of the central structure outside the slot. The central shaft 158 also functions as an attachment location for the spring 152.

As shown in FIGS. 9 and 10, the stake magazine 118 is an elongated tube shape with a rectangular thin-walled profile and a channel 164 extending along the upward-facing wall thereof. The stake magazine 118 has slide supports 162 on opposing longitudinal sides of the rectangular profile that are configured to contact and support opposing surfaces of the plurality of stakes 120 (FIG. 11) held in the stake magazine 118. The slide supports 162 thereby border opposing sides of the channel 164 that longitudinally extends along the magazine. The length of the stake magazine 118 thereby defines the stake loading capacity, such that it is understood that the stake magazine may be longer or shorter than the examples illustrated, such as for larger or reduced capacity or alternatively for differently sized or configured stakes.

As shown in FIG. 11, the stakes 120 are arranged in the channel 164 of the stake magazine 118 where the side surface of the stakes 120 are supported on the slide supports 162. Specifically, such as shown in FIGS. 12-15, the stakes 120 include upper support pegs or hanger pegs 166 that protrude laterally from the head of each stake 120. The support pegs 166 slidably engage the upper surface of the slide supports 162. The head 168 of the stakes 120 each include a triangular retention hook 178 that extends from the head 168 toward a pointed tip at a separation from the shank 170 of the stakes 120. The stakes 120 each include a shank 170 that extends from the head 168 toward a pointed tip 172. The cross-sectional shape of the shank, taken transverse to its length, is T-shaped. The lower portion of the shank has an angled lower surface 174 that is configured to be parallel to and/or slide along the bottom interior surface 165 of the channel 164, such as shown in FIG. 15.

As also shown in FIG. 15, the stakes 120 may be interconnected, such as being molded together in parallel alignment at an angle corresponding to the angle of the stake magazine. The stakes 120 are molded together with spacer pieces 176 integrally connecting adjacent stakes of the plurality of stakes. The shanks 170 of adjacent stakes 120 extend in parallel alignment with each other, maintaining consistent angular orientation relative to the magazine axis. As explained above, when the lowermost stake 120_{L} is driven downward, the integral connections provided by the spacer pieces 176 break away, allowing the lowermost stake 120_{L} to separate from the adjacent stake as it moves downward in the chamber toward the ground substrate. As shown in FIGS. 12-15, the stakes include at least two spacer pieces that interconnect the adjacent stakes and provide a desired and fixed spacing between the stakes, which prevents the adjacent stake to the lowermost stake from inadvertently feeding into the chamber between contact with the head of the lowermost stake and the impactor being driven in front of the opening in the sidewall of the guide tube, where the side surface 133 of the hammer shaft retains the remainder of the plurality of stakes in the magazine.

As shown in FIGS. 16-24, an additional example of a stake 220 and a corresponding set of stakes 220 is provided that can be provided in a stake strip 221 (FIGS. 16 and 18) with interconnected stakes 220 that are molded together with the shanks 270 in parallel alignment and offset from each other at an angle corresponding to the angle of the stake magazine. The example shown in FIGS. 16 has a set of six stakes 220 molded together to form the stake strip 221. Again, it is understood that more or fewer stakes may be molded together in a stake strip in additional examples. The stakes 220 are molded together with spacer pieces 276 integrally connecting the adjacent stakes 220 of the plurality of stakes. The spacer pieces 276 provide a desired and fixed spacing between the shanks 270 of the stakes 220, which prevents the adjacent stake to the lowermost stake from inadvertently feeding into the chamber of the guide tube after the lowermost stake is driven down.

As shown in FIG. 17, which isolates the lower three stakes 220 of the stake strip 221, the spacer pieces 276 are configured as sacrificial pins with a predetermined break point B. The break point B is positioned near the rearward end of each spacer piece 276_{L} where it connects to the front wall of the adjacent, vertically higher stake 220. When the lowermost stake 220L is driven downward by the impactor member 132, shear forces concentrate at the break point B, causing clean separation of the spacer pieces 276L. To facilitate controlled breaking, the spacer pieces 276 may include a reduced cross-sectional area, notch, groove, or other weakened portion at the break point B. After separation, a minimal portion (or no portion) of the broken spacer pieces 276L remains on the driven stake, while a small remaining piece may remain attached to the shank 270 of the adjacent stake 220 retained in the magazine. The spacer pieces may be configured to have more or less, or none, remaining when broken off from the adjacent stake.

The stakes 220 shown in FIGS. 16-24 each include three spacer pieces 276 that interconnect the adjacent stakes. The spacer pieces 276, such as shown in FIGS. 19 and 20, are provided as cylindrical projections that extend perpendicular to the longitudinal extents of the interconnected shanks 270. The spacer pieces 276 may also be offset from each other on the shank to increase stability between the shanks, which can improve reliable feeding along the magazine. As shown in FIGS. 19 and 20, the uppermost spacer piece 276 is offset to the left side of the shank 270, the middle spacer piece 276 is offset to the right side of the shank 270, and the lowermost spacer piece 276 is centered on the shank of the stake. This offset may be altered in additional examples by different spacer pieces to similarly provide the torsional strength and stability between the stakes.

As shown in FIG. 18, the slide supports 262 on opposing sides of the channel on the stake magazine are used to support the upper support pegs or hanger pegs 266 that protrude laterally from the head of each stake 220. The lower surface of the support pegs 266 slidably engages the upper surface of the slide supports 262. Optionally, the stake magazine may also include an upper guide bar 284 that engages the upper surface of the head 268 (FIG. 19) and/or the support pegs 266 of the stakes 220 to retain the stakes in the channel as they are fed into the chamber and generally prevent vertical movement of the stakes in the lower end of the magazine. The support pegs 266, as shown in FIGS. 21 and 22, are located at the same location on opposing sides of the stake and are generally centered on the shank of the stake. The support pegs 266 thereby function as alignment features that maintain proper orientation of the stakes 220 as they slide down the magazine toward the chamber.

As further shown in FIG. 18, the lower edge 274 of the stake 220 is generally linear and angled relative to the length of the shank, where the angle of the lower edge 274 is configured to be parallel to and/or slide along the bottom interior surface 265 of the magazine. By providing the lower edge 274 at the desired declined angle that corresponds to the angle of the magazine, the stakes are reliably maintained in a vertical orientation and parallel to each other as they are fed and advanced down the magazine.

The head 268 of the stake is integrally formed with the upper end of the shank 270 of the stake 220 and is enlarged relative to the shank, such as to have a larger horizontal area than the shank. As shown in FIGS. 19-24, the head of each stake 220 includes a retention hook 278 that extends from the head 268 toward a pointed tip, which is a spaced distance from the shank 270 of the stakes 220. The hook 278 has a triangular shape, as shown in FIG. 20, protruding vertically and in parallel with the rear wall of the stake and terminating at the pointed tip. The spacing of the pointed tip of the retention hook 278 away from the shank 270 allows the tip to engage the ground surface and material or objects that are being attached to the ground surface with the stake, such as a mat or ground covering.

As also shown in FIGS. 19-24, the shank 270 in the additional example of the stake 220 extends linearly from the head 268 downward toward a pointed tip 272 and includes a serrated edge portion 286. The serrated edge portion 286 assists with forming a frictional engagement with the ground upon engagement, which resists withdrawal forces on the stake and provides enhanced engagement with the ground substrate. The serrated edge portion may be provided at one or more longitudinal edges along one or more longitudinal sections of the shank. As shown in FIGS. 19-22, the serrated edge portion 286 is provided along the rearward-facing edge of the shank 270 and along a central section of the shank 270, above the angled lower edge 274 and below the middle spacer piece 276. As such, the lowermost spacer piece 276 integrally extends from the serrated edge portion 286. The serrated edge portion 286 has a sinusoidal wave shape; however, additional shapes may be provided in other examples, such as a sawtooth shape or other serrated shapes. The cross-sectional shape of the shank, taken transverse to its length as seen in FIG. 24, is T shaped. It is also understood that the stake may be formed with different cross-sectional shapes, such as a + shaped cross-section (with four perpendicular flanges extending from a central axis), a U shaped or C-shaped channel cross-section (providing a concave surface), an I-beam or H-beam configuration, or various other shapes that provide structural rigidity while minimizing material usage and facilitating penetration into the ground substrate.

The stake strips 221 described herein provide a significant advantage for use with stake driving tools. By maintaining the stakes in parallel alignment with fixed spacing via the spacer pieces 276, the stake strips ensure reliable gravity feeding through the magazine 318 and consistent positioning for engagement by the hammer shaft. The longitudinal offset between adjacent stake heads (e.g., the distance between the first head portion of one stake and the second head portion of an adjacent stake) corresponds to the angle of the stake magazine, allowing the lowermost stake to align with the chamber while the adjacent stake remains retained in the magazine. This configuration enables progressive stake driving without manual reloading between stakes.

While the embodiment of FIGS. 1-11 utilizes laterally extending handle grips that move through a slot 136 in the guide tube 114, alternative handle configurations may provide ergonomic or operational advantages in certain applications. Referring to FIGS. 25-28, an additional example of a system 300 is provided with a portable tool 310 for also manually driving stakes, such as compostable, biodegradable landscape stakes 120, 220, into a ground substrate G. As shown in FIG. 25, the tool 310 has a similar construction to the example shown in FIGS. 1-11, and includes a base plate 312, a guide tube 314, a hammer shaft contained in the guide tube 314, and a stake magazine 318. The hammer shaft is constructed like the hammer shaft 116 shown in FIG. 5 and is slidably disposed within the guide tube 314 and moves between a raised position and a lowered position, allowing for controlled impact on the stake head. Also, the stake magazine 318 is attached to the lower portion 328 of the guide tube 314, extending radially from the guide tube and upward at an angle that allows the stakes to be gravity fed into the guide tube 314 during operation of the tool. The stake magazine 318 holds a plurality of interconnected stakes, such as one or more interconnected sets or strips of stakes, facilitating generally continuous operation and reducing the need for frequent reloading. The chamber in the lower portion 328 of the guide tube 314 is aligned with the open end of the stake magazine 318 and provides an opening in the sidewall of the guide tube 314 that is in communication with the interior of the stake magazine 318. The stake magazine 318 allows for the generally hands-free feeding of stakes into the guide tube 314, providing a smooth and efficient driving process.

To provide a location for the handle 334 that allows a user in a standing stance to have leverage to easily drive the hammer shaft downward, the handle 334 of the stake driving tool 310 is coupled with an upper portion of the hammer shaft, which is otherwise constructed like the hammer shaft 116 shown in FIG. 5. While similarly operating the hammer shaft up and down between the raised and lowered positions, as shown in FIGS. 25-28, the handle 334 has a handle grip extending upward from the top end of the guide tube 314. Instead of extending laterally from a guide tube, the handle 334 shown in FIGS. 25-28 has a collar that functions as a slide limiter 380 that is configured to contact a stop surface on the guide tube 314 when the hammer shaft is in the lowered position (FIG. 26). As shown, the stop surface on the guide tube 314 is the top end surface of the guide tube 314. The slide limiter 380 thereby limits downward movement of the handle 334 and, in turn, limits the potential downward movement of the attached hammer shaft beyond the lowered position. Accordingly, the handle 334 may not provide a limit to the upward movement of the handle, which allows the user to raise the handle higher where more force may be necessary, such as more compact ground or otherwise hard soil or substrate that requires a higher force to drive the stake into the ground.

To provide manual portability of the tool by hand, as shown in FIGS. 25-28, carry handles 342 are attached to the guide tube 314. The carry handles 342 are attached to opposing sides of the tool, providing convenient and ergonomic locations for users to lift and maneuver the stake driving tool 310.

Additionally, as shown in FIG. 26, the stake magazine 318 is similarly an elongated tube shape with a rectangular thin-walled profile and a channel 364 (FIG. 28) extending along the upward-facing wall thereof. The stake magazine 318 also has slide supports 362 on opposing longitudinal sides of the rectangular profile that are configured to contact and support opposing surfaces of the plurality of stakes held in the stake magazine 318. In addition, the stake magazine has a side window 382 that provides a visual indicator for determining the number of stakes remaining in the magazine by viewing the degree of full or empty as a proportion of the viewing window. The side window 382 may include graduated markings or other visual indicia that allow a user to quickly assess how many stakes remain loaded in the magazine 318 without disassembling the tool or interrupting operation. The upper portion of the stake magazine 318 also has an L-shaped alignment bar 384 that contacts the heads of the stakes to assist with aligning the stakes as they enter the guide tube.

Referring to FIG. 29, a chart is provided illustrating a method for driving a landscape stake into a ground substrate using a stake driving tool. The method, at step 90, provides positioning a base plate of the stake driving tool on a ground surface to provide a stable foundation. In some examples, the tool may include a carry handle fixed to an exterior side wall of the guide tube for supporting the tool in operation and for moving the tool over the ground surface. At step 92, a plurality of interconnected stakes are loaded into a stake magazine attached to a lower portion of a guide sleeve extending upward from the base plate, the guide sleeve defining a hollow interior; aligning a lowermost stake of the plurality of interconnected stakes with a chamber in the lower portion of the guide sleeve through an opening in the stake magazine. At step 94, a hammer shaft slidably disposed within the hollow interior of the guide sleeve is raised to a raised position, allowing the chamber to receive the lowermost stake. At step 96, the hammer shaft is moved from the raised position toward a lowered position, where a lower end of the hammer shaft engages a head of the lowermost stake. At step 98, the lowermost stake is driven down the lower portion of the guide sleeve and into the ground surface by the movement of the hammer shaft. The steps may be repeated for subsequent stakes in the stake magazine as needed. The stake magazine is configured to move stakes into the guide sleeve under the weight of gravity and includes a visual indicator to show the number of remaining stakes.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote one element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A tool for driving a landscape stake, the tool comprising:
a guide tube having a hollow interior disposed along a longitudinal extent of the guide tube;
a stake magazine attached to a lower portion of the guide tube and having an interior configured to hold a plurality of stakes; and
a hammer shaft slidably disposed in the hollow interior of the guide tube and movable between a raised position and a lowered position,
wherein when in the raised position, a lowermost stake of the plurality of stakes is configured to move from the stake magazine into the lower portion of the guide tube, and
wherein when moved from the raised position toward the lowered position, a lower end of the hammer shaft is configured to engage a head of the lowermost stake in the guide tube and drive it down into a ground surface.

2. The tool of claim 1, wherein an upper end of the hammer shaft is attached to a handle operable for a user to move the hammer shaft between the raised position and the lowered position.

3. The tool of claim 2, wherein the handle includes a slide limiter configured to contact a stop surface on the guide tube when the hammer shaft is in the lowered position.

4. The tool of claim 1, wherein the lower end of the hammer shaft includes an impactor member, and wherein the lower portion of the guide tube receives the lowermost stake in axial alignment with the hammer shaft.

5. The tool of claim 1, wherein the stake magazine includes an upward-facing channel that defines slide supports on opposing longitudinal sides of the upward-facing channel, and wherein the slide supports are configured to support the plurality of stakes in the upward-facing channel.

6. The tool of claim 1, wherein when the hammer shaft is in the lowered position, a side surface of the lower end of the hammer shaft is configured to retain a remainder of the plurality of stakes in the stake magazine.

7. The tool of claim 1, wherein the lower end of the hammer shaft is generally aligned with a bottom end of the guide tube when the hammer shaft is in the lowered position.

8. The tool of claim 1, further comprising a carry handle fixed to an exterior side wall of the guide tube for supporting the tool in operation and for moving the tool over the ground surface.

9. The tool of claim 1, further comprising a base plate coupled to a bottom end of the guide tube and configured to contact the ground surface.

10. The tool of claim 1, wherein the lower portion of the guide tube defines a chamber with an opening that is in communication with the interior of the stake magazine.

11. A system comprising:
a stake driving tool having:
a guide tube with a hollow interior,
a stake magazine extending from a lower portion of the guide tube at an angle, and
a hammer shaft slidably disposed in the hollow interior of the guide tube and movable between a raised position and a lowered position, and
a stake strip slidably disposed in the stake magazine and having a plurality of stakes interconnected and arranged to correspond to the angle of the stake magazine,
wherein when the hammer shaft is in the raised position, a lowermost stake of the plurality of stakes is configured to feed into the hollow interior at the lower portion of the guide tube, and
wherein when the hammer shaft is moved from the raised position toward the lowered position, a lower end of the hammer shaft is configured to engage a head of the lowermost stake and drive it into a ground surface.

12. The system of claim 11, wherein the stake magazine includes an upward-facing channel that defines slide supports on opposing longitudinal sides of the upward-facing channel.

13. The system of claim 12, wherein the plurality of stakes includes alignment features that slidably engage the slide supports of the stake magazine.

14. The system of claim 11, wherein each of the plurality of stakes is arranged in parallel alignment with each other.

15. The system of claim 11, wherein the plurality of stakes is molded of a biodegradable composite material.

16. The system of claim 11, wherein when the hammer shaft is moved from the raised position toward the lowered position, the lowermost stake is broken away from the stake strip.

17. The system of claim 11, wherein when the hammer shaft is in the lowered position, a side surface of the lower end of the hammer shaft is configured to retain a remainder of the plurality of stakes in the stake magazine.

18. The system of claim 11, wherein the stake strip comprises:
a first stake having a first head portion and a first shank portion extending from the first head portion,
a second stake having a second head portion and a second shank portion extending from the second head portion, and
a spacer piece connecting the first stake and the second stake to maintain the first shank portion and the second shank portion in parallel alignment at a spaced distance from each other.

19. The system of claim 18, wherein the first shank portion includes a first lower edge that is generally linear and the second shank portion includes a second lower edge that is generally linear and aligned with the first lower edge of the first shank portion to correspond to the angle of the stake magazine.

20. A method for driving stakes, the method comprising:
positioning a base plate of a stake driving tool on a ground surface;
loading a plurality of interconnected stakes into a stake magazine attached to a lower portion of a guide tube extending upward from the base plate, the guide tube defining a hollow interior;
raising a hammer shaft slidably disposed within the hollow interior of the guide tube to a raised position to allow the lower portion of the guide tube to receive a lowermost stake of the plurality of interconnected stakes from the stake magazine;
moving the hammer shaft from the raised position toward a lowered position, wherein a lower end of the hammer shaft engages a head of the lowermost stake; and
moving the hammer shaft to the lowered position to drive the lowermost stake down the lower portion of the guide tube and into the ground surface.
